(19) United States
(12) Patent Application Publication
(10) Pub. No.: US 2013/0017071 A1
(43) Pub. Date: Jan. 17, 2013

(54) FOAM STRUCTURE, A PROCESS OF FABRICATING A FOAM STRUCTURE AND A TURBINE INCLUDING A FOAM STRUCTURE

(71) Applicants: George Albert GOLLER, Greenville, SC (US); Dennis William CAVANAUGH, Simpsonville, SC (US)

(72) Inventors: George Albert GOLLER, Greenville, SC (US); Dennis William CAVANAUGH, Simpsonville, SC (US)

(73) Assignee: GENERAL ELECTRIC COMPANY, Schenectady, NY (US)

(21) Appl. No.: 13/181,887

(22) Filed: Jul. 13, 2011

(51) Int. Cl. F01D 11/00; B32B 5/18; B05D 3/00; B32B 15/04

(52) U.S. Cl. 415/174.4; 428/539.5; 427/295

(57) ABSTRACT

Disclosed is a foam structure, a process of fabricating the foam structure, and a turbine including the foam structure. The foam structure includes a cast metallic foam having pores and a gel positioned within at least a portion of the pores. The process of fabricating the foam structure includes providing the cast metallic and infusing the cast metal foam with the gel. The turbine includes a rotating portion and a turbine seal including the foam structure.

### FIELD OF THE INVENTION

The present invention relates to manufactured components and processes of manufacturing components. More specifically, the present invention relates to metallic foams and process of fabricating metallic foams.

### BACKGROUND OF THE INVENTION

Manufactured components are increasingly subjected to difficult environments. For example, gas turbine components are subjected to thermally, mechanically and chemically hostile environments. For example, in the compressor portion of a gas turbine, atmospheric air is compressed to 10-25 times atmospheric pressure, and adiabatically heated to about 800° F. to about 1250° F. in the process. This heated and compressed air is directed into a combustor, where it is mixed with fuel. The fuel is ignited, and the combustion process heats the gases to very high temperatures, in excess of about 3000° F. These hot gases pass through the turbine, where airfoils fixed to rotating turbine disks extract energy to drive the fan and compressor of the turbine, and the exhaust system, where the gases provide sufficient energy to rotate a generator rotor to produce electricity. Tight seals and precisely directed flow of the hot gases provides operational efficiency. To achieve such tight seals in turbine seals and precisely directed flow can be expensive.

Traditionally, foam structures have not been used in such harsh environments. It has been believed that only high alloy honeycomb materials were capable of withstanding such types of environments. Likewise, foam structures have not been used in other environments due to what were believed to be similar limitations.

A foam structure, and a method of fabricating a foam structure, and a turbine including a foam structure that are capable of operating within the above conditions would be desirable in the art.

### BRIEF DESCRIPTION OF THE INVENTION

In an embodiment, a foam structure includes a cast metallic foam having pores and a gel within at least a portion of the pores.

In another embodiment, a process of fabricating a foam structure includes providing a cast metallic foam having pores and infusing at least a portion of the pores with a gel.

In another embodiment, a turbine includes a rotating portion and a turbine seal. The turbine seal includes a foam structure. The foam structure includes a cast metallic foam having pores and a gel positioned within at least a portion of the pores.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a portion of an exemplary turbine having a metallic foam mechanically secured to a backing plate by a fastener according to the disclosure.

FIG. 2 show a side schematic view of an exemplary turbine seal having a metallic foam brazed to sidewalls according to the disclosure.

FIG. 3 shows a side schematic view of an exemplary metallic foam having fine porosity according to the disclosure.

FIG. 4 shows a side schematic view of an exemplary metallic foam having coarse porosity according to the disclosure.

FIG. 5 shows a side schematic view of an exemplary turbine seal having a metallic foam brazed to a backing plate according to the disclosure.

FIG. 6 shows a side schematic view of an exemplary turbine seal having a metallic foam mechanically secured to sidewalls by a fastener according to the disclosure.

FIG. 7 shows a perspective view of an exemplary turbine seal having a metallic foam mechanically secured to a backing plate by a latch according to the disclosure.

FIG. 8 shows a perspective view of an exemplary turbine seal having a metallic foam mechanically secured to sidewalls by a latch according to the disclosure.

FIG. 9 shows a perspective view of an exemplary turbine seal having a metallic foam mechanically secured to a backing plate by an interlocking feature according to the disclosure.

FIG. 10 shows a perspective view of an exemplary turbine seal having a metallic foam mechanically secured to sidewalls by an interlocking feature according to the disclosure.

FIG. 11 shows a perspective view of an exemplary turbine seal having a metallic foam mechanically secured to a backing plate by a lip according to the disclosure.

FIG. 12 shows a perspective view of an exemplary turbine seal having a metallic foam mechanically secured to sidewalls by a lip according to the disclosure.

Wherever possible, the same reference numbers will be used throughout the drawings to represent the same parts.

### DETAILED DESCRIPTION OF THE INVENTION

Provided is a lower-cost turbine seal and method of fabricating a turbine seal capable of operating within the above conditions. Embodiments of the present disclosure permit use of less expensive materials in hot gas path regions, permit simpler and/or less expensive assembly and/or repair of turbine seals, permit improved operational efficiency of gas turbines, permit increased oxidation resistance, and combinations thereof.

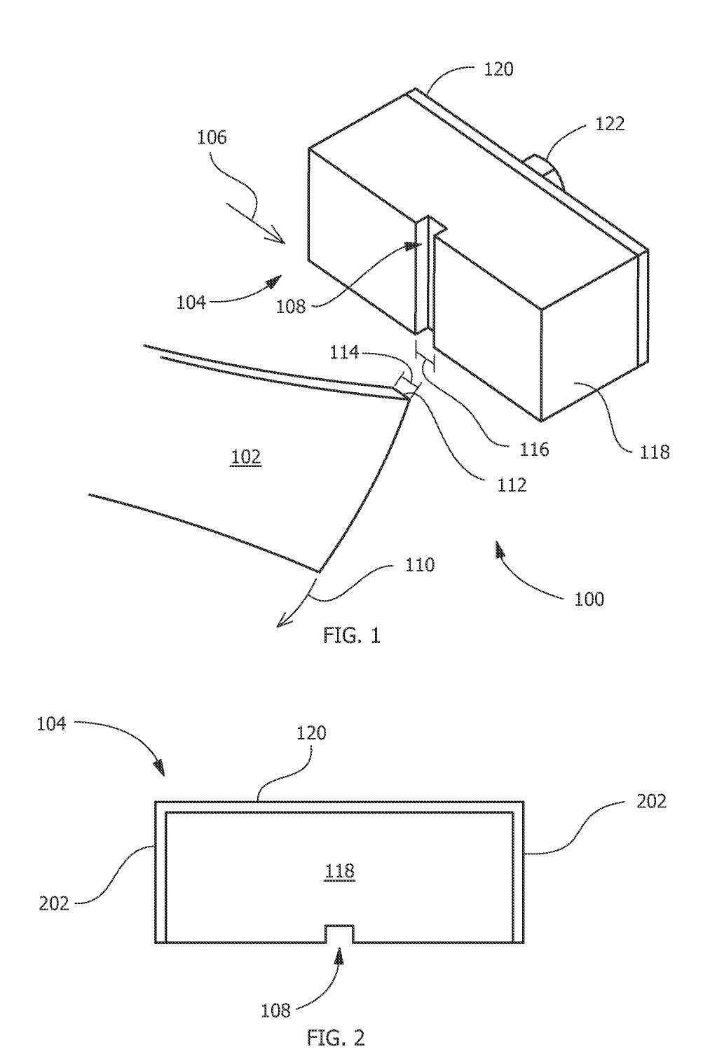

FIG. 1 shows portions of a turbine 100, such as a gas turbine, including a rotating portion 102, such as a blade, and a turbine seal 104 or shroud seal. A hot gas path 106 passes along the turbine seal 104 rotating the rotating portion 102 through a groove 108 or seal cut along a predetermined path 110 within the turbine seal 104. The rotating portion 102 includes an edge 112 having a predetermined thickness 114. For example, in one embodiment, the predetermined thickness 114 is between about ¼ inch and about ¾ inch, between about ¼ inch and about ½ inch, about ¼ inch, or about ½ inch.

The predetermined thickness 114 corresponds to a predetermined thickness 116 of the groove 108. For example, in one embodiment, the predetermined thickness of the edge 112 is slightly smaller than the predetermined thickness of the groove 108 and/or is formed by rotating the rotating portion 102 to abrade the turbine seal 104 to form the groove 108. In one embodiment, the predetermined thickness 116 of the groove 108 is between about ¼ inch and about ¾ inch, between about ¼ inch and about ½ inch, about ¼ inch, or about ½ inch. In one embodiment, the difference between the predetermined thickness 114 of the edge 112 and the predetermined thickness 116 of the groove 108 permits the rotating portion 102 to rotate without contacting the turbine seal 104 but provides a seal that reduces or eliminates the amount of the hot gas path 106 traveling between the turbine seal 104 and the rotating portion 102.

The turbine seal 104 is any suitable geometry. FIG. 1 shows a cuboid geometry; however, in other embodiments, the turbine seal 104 is an arched geometry, a substantially planar geometry, a complex geometry increasing in depth along the hot gas path 106, or any other geometry providing a seal. The turbine seal 104 includes one unitary piece of material or multiple pieces of material secured together, for example, by brazing, mechanical securing, welding or other suitable securing processes. The turbine seal 104 is formed outside of the turbine 100 or within the turbine 100 as part of a repair method.

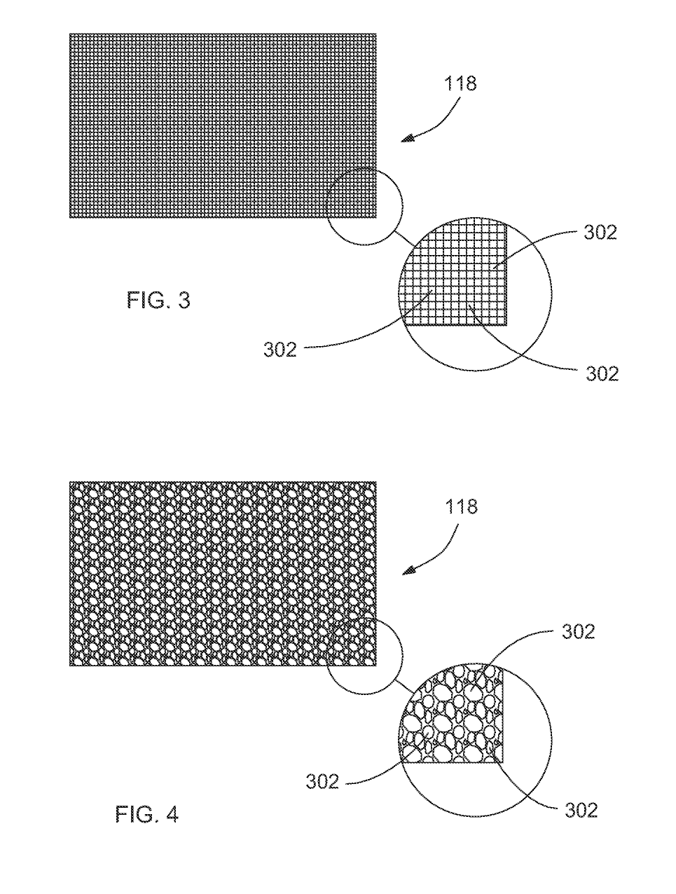

The turbine seal 104 includes a metallic foam 118 positioned along the hot gas path 106. Referring to FIGS. 3-4, the metallic foam 118 is selected for the specific operational parameters. For example, in one embodiment, the metallic foam 118 is resistant to temperatures between about 1000° F. and about 2000° F., about 1000° F., about 1250° F., about 1500° F., about 2000° F., or about 3000° F., resulting from the hot gas path 106 of the turbine 100. The metallic foam 118 includes a network of pores 302. Referring to FIG. 3, in one embodiment, the pores 302 are barely visually discernible or have a fine porosity. Referring to FIG. 4, in another embodiment, the pores 302 are complex and do not have a consistent geometry, similar to steel wool, or have a course porosity. The pores 302 are any suitable size and within any suitable density. Suitable sizes of pores 302 are between about 1 and about 100 pores per inch, between about 10 and about 50 pores per inch, between about 30 and about 40 pores per inch, between about 50 and about 100 pores per inch, between about 50 and about 70 pores per inch, or combinations thereof. Suitable densities of pores 302 are between about 2% and about 15%, about 3% and about 10%, about 5% and about 7%, and combinations thereof

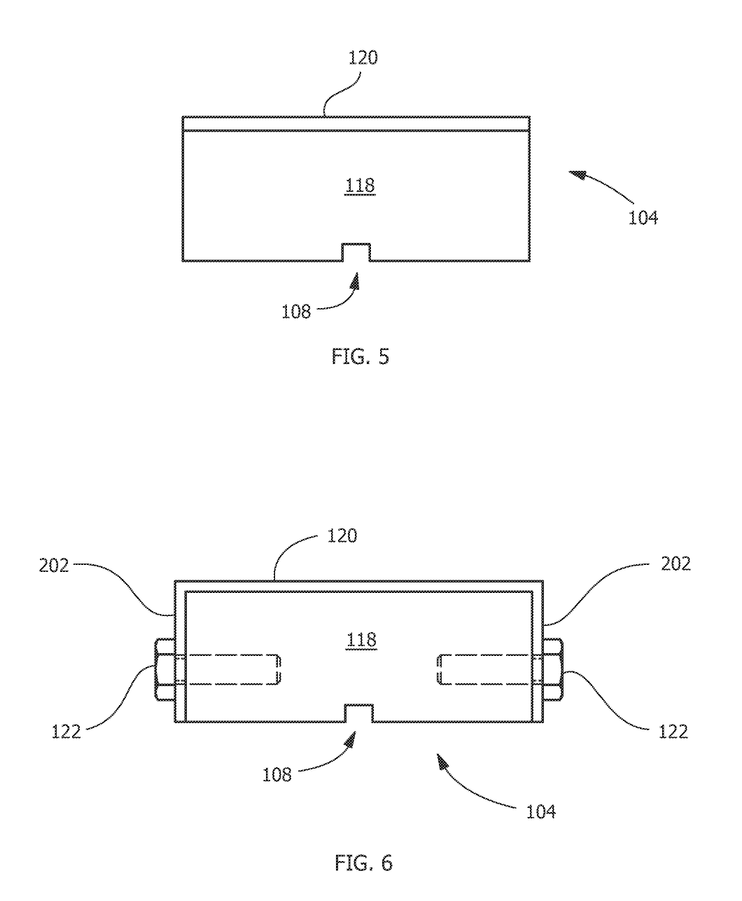

The metallic foam 118 is secured to a position along the hot gas path 106. The securing is to a backing plate 120 and/or sidewalls 202. In one embodiment, the metallic foam 118 is secured by brazing or welding the metallic foam 118 to the backing plate 120 (see FIG. 5) and/or the sidewalls 202 (see FIG. 2).

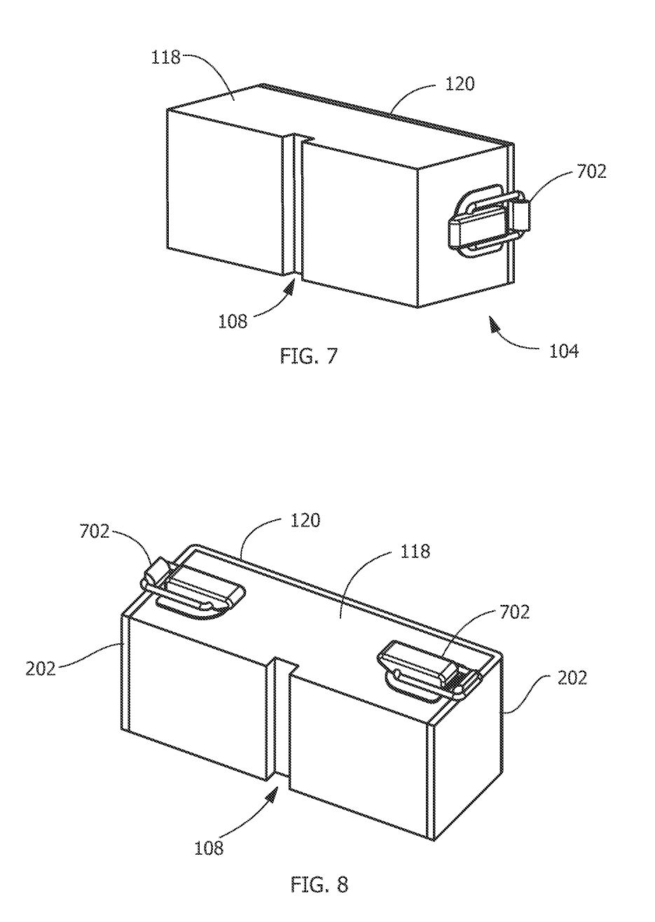

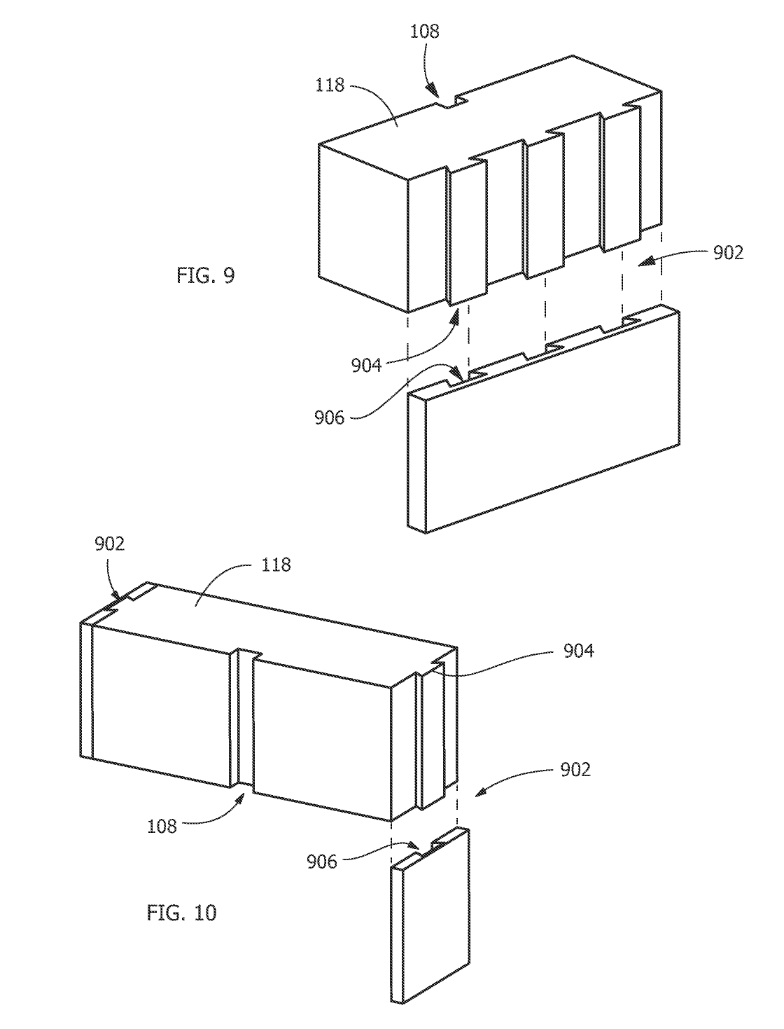

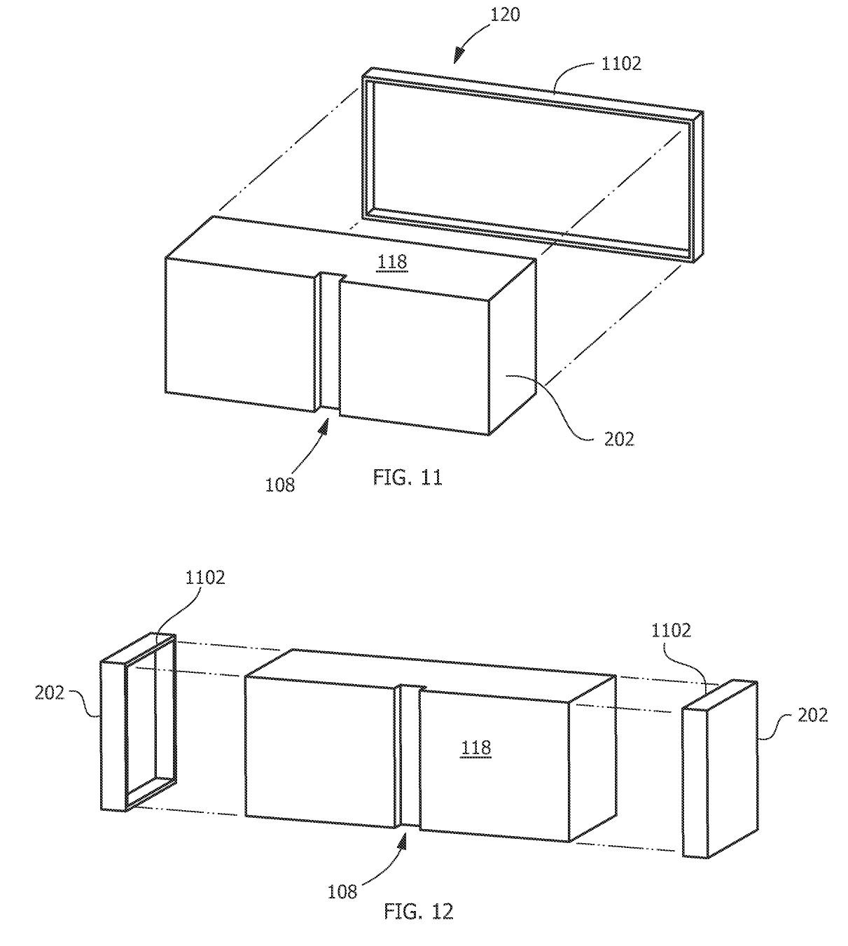

In another embodiment, the metallic foam 18 is secured by mechanically securing to the backing plate 120 and/or the sidewalls 202. The mechanical securing is by any suitable mechanism, including, but not limited to, a fastener 122 such as a bolt (see FIGS. 1 and 6), a latch 702 (see FIGS. 7 and 8), an interlocking feature 902 (see FIGS. 9 and 10), a lip 1102 (see FIGS. 11 and 12), another suitable mechanism, or combinations thereof.

Referring to FIG. 1, in one embodiment, the metallic foam 118 is secured in position by mechanically securing the metallic foam 118 to the backing plate 120. In this embodiment, the fastener 122 extends through the backing plate 120 into the metallic foam 118 and is fixed in place. The fastener 122 extends through the entire metallic foam 118 or a portion of the metallic foam 118 at any suitable orientation. Suitable orientations include, but are not limited to, being substantially parallel to the hot gas path 106, being substantially parallel to the backing plate 120, being substantially perpendicular to the sidewalls 202, being at an angle other than parallel or perpendicular with the backing plate 120 and/or the sidewalls 202, other suitable orientations, or combinations thereof.

Referring to FIG. 6, in one embodiment, the metallic foam 118 is secured in position by mechanically securing the metallic foam 118 to one or more of the sidewalls 202. In this embodiment, the fastener 122 extends through the sidewall(s) 202 into the metallic foam 118 and is fixed in place. The fastener 122 extends through the entire metallic foam 118 or a portion of the metallic foam 118 at any suitable orientation. Suitable orientations include, but are not limited to, being substantially parallel to the hot gas path 106, being substantially parallel to the backing plate 120, being substantially perpendicular to the sidewalls 202, being at an angle other than parallel or perpendicular with the backing plate 120 and/or the sidewalls 202, other suitable orientations, or combinations thereof.

In one embodiment, the metallic foam 118 is additionally or alternatively mechanically secured by the latch 702 to the backing plate 120 and/or the sidewalls 202. Referring to FIG. 7, in one embodiment, the latch 702 includes a latch catch 704 and a latch member 706 for engaging the latch catch 704. The latch catch 704 includes an open portion capable of being secured to the latch member 706. Either the latch catch 704 or the latch member 706 is positioned on the metallic foam 118 and the other is positioned on the backing plate 120. Upon securing the latch catch 704 to the latch member 706, the turbine seal 104 is secured in position. The latch 702 includes any suitable fine adjustment mechanisms (not shown). Suitable fine adjustment mechanisms include, but are not limited to, tightening screws, adjustable sizes, or any other suitable mechanism permitting the securing of the latch 702 to be adjusted. Additionally or alternatively, referring to FIG. 8, in one embodiment, either the latch catch 704 or the latch member 706 is similarly positioned on the metallic foam 118 and the other is positioned on one or more of the sidewalls 202.

In one embodiment, the metallic foam 118 is additionally or alternatively mechanically secured by the interlocking feature 902 (such as a tongue and groove feature) to the backing plate 120 and/or the sidewalls 202. Referring to FIG. 9, in one embodiment, the interlocking feature 902 includes a protrusion 904 (or a tongue portion) and a corresponding recess 906 (or a groove portion) for engaging the protrusion 904. The protrusion 904, the recess 906, or a combination thereof are positioned on the metallic foam 118. A corresponding protrusion 904 and/or recess 906 are positioned on the backing plate 120 (see FIG. 9), on one or more of the sidewalls 202 (see FIG. 10), or combinations thereof. The interlocking feature 902 is positioned along any suitable orientation. Suitable orientations include, but are not limited to, being substantially parallel to the hot gas path 106, being substantially parallel to the backing plate 120, being substantially perpendicular to the sidewalls 202, being at an angle other than parallel or perpendicular with the backing plate 120 and/or the sidewalls 202, other suitable orientations, or combinations thereof. In one embodiment, the interlocking feature 902 permits the turbine seal 104 to be inserted into the backing plate 120 and mechanically secured based upon being forced into place.

Referring to FIG. 11, in one embodiment, the metallic foam 118 is additionally or alternatively mechanically secured by the lip 1102 (for example, extending around the metallic foam 118 and/or forming a friction fit) to the backing plate 120. Referring to FIG. 12, in one embodiment, the metallic foam 118 is additionally or alternatively mechanically secured by the lip 1102 to the sidewalls 202. The lip 1102 is sized slightly smaller than the back and/or sides of the metallic foam 118, thereby permitting the metallic foam 118 to be forcibly positioned and secured within the lip 1102.

The metallic foam 118 is any suitable alloy or metal. In one embodiment, the metallic foam 118 includes stainless steel. In another embodiment, the metallic foam 118 includes a nickel-based alloy. Other suitable alloys include, but are not limited to, cobalt-based alloys, chromium-based alloys, carbon steel, and combinations thereof. Suitable metals include, but are not limited to, titanium, aluminum, and combinations thereof. As will be appreciated by those skilled in the art, the selection of the alloy or metal in the metallic foam 118 corresponds with the desired operational temperatures. However, less expensive alloys and/or metals may be selected based upon increased operational capabilities resulting from a gel infusion/impregnation treatment described below. Additionally or alternatively, the gel increases oxidation resistance of the metallic foam 118.

Referring to FIGS. 3-4, in one embodiment, the metallic foam 118, for example, a cast metallic foam is infused/impregnated with a gel (not shown) or slurry. The gel is positioned within at least a portion of the pores 302, for example, substantially all of the pores 302, about half of the pores 302, about one quarter of the pores 302, or any other suitable portion of the pores 302. The infusing of the metallic foam 118 is performed by any suitable process, including, but not limited to, vacuum infusion methods, chemical vapor deposition, vapor phase aluminizing, and/or other suitable processes. The gel travels through all or a portion of the metallic foam 118 by force provided through the vacuum infusion method, thereby filling some or all of the pores 302 of the metallic foam 118.

The cast metallic foam is formed from any suitable cast metal alloy. For example, in one embodiment, the cast metallic alloy is a nickel-based alloy having a compositional range, by weight, of up to about 15% chromium, up to about 10% cobalt, up to about 4% tungsten, up to about 2% molybdenum, up to about 5% titanium, up to about 3% aluminum, and up to about 3% tantalum. In a further embodiment, the cast metallic alloy has a composition, by weight, of about 14% chromium, about 9.5% cobalt, about 3.8% tungsten, about 1.5% molybdenum, about 4.9% titanium, about 3% aluminum, about 0.1% carbon, about 0.01% boron, about 2.8% tantalum, and a balance of nickel.

The gel is any suitable slurry capable of being infused within the metallic foam 118. For example, one suitable gel is a gel aluminide slurry. The gel includes a metallic component, a halide activator, and a binder. The composition of the gel provides a consistency permitting application to the turbine seal 104 by spraying, dipping, brushing, or injection.

The composition of the gel is, by weight, between about 10% and about 90% solids (the metallic component and the halide activator) with a balance being the binder. In further embodiments, with the remainder being the binder, the halide activator, and impurities, the metallic component is, by weight between about 35% and about 65%, between about 45% and about 60%, between about 50% and about 55%, or any subrange within. In these embodiments, with the remainder being the metallic component, the halide activator, and impurities, the binder is, by weight, between about 25% and about 60%, between about 25% and about 50%, between about 35% and about 40%, or any subrange within. In these embodiments, with the remainder being the binder, the metallic component, and impurities, the halide activator is, by weight, between about 1% and about 25%, between about 5% and about 25%, between about 10% and about 15%, or any subrange within.

In one embodiment, the gel has a predetermined melting point. The melting point of the gel exceeds the melting point of metallic foam 118, for example, about 1220° F. for aluminum. As such, by infusing the metallic foam 118 with the gel, the melting point of the resulting structure (for example, the seal structure) is increased.

The gel is devoid of particles larger than a predetermined size. For example, in one embodiment, the gel is devoid of particles larger than about 74 micrometers. In another embodiment, the gel is devoid of particles larger than about 149 micrometers.

The metallic component of the gel includes any suitable metal or alloy capable of forming a slurry with the halide activator and the binder. The metallic component is an alloying agent having a sufficiently high melting point so as not to deposit during a diffusion process. The metallic component serves as an inert carrier of a metal, for example, aluminum.

In one embodiment, the metallic component is metallic aluminum alloyed with chromium, for example, having a composition, by weight, of about 56% chromium and about 44% aluminum, with any remainder being aluminum and/or incidental impurities. Other suitable compositions, include but are not limited, about 30% chromium and about 70% aluminum, about 70% chromium and about 30% aluminum, about 40% chromium and about 60% aluminum, about 60% chromium and about 40% aluminum, and about 50% chromium and about 50% aluminum. In another embodiment, the metallic component includes a metallic aluminum alloyed with cobalt. In another embodiment, the metallic component includes metallic aluminum alloyed with iron.

The halide activator corresponds to the selected metallic component of the gel and/or composition of the metallic foam 118. In one embodiment, the halide activator is in the form of a fine powder. Suitable halide activators include, but are not limited to, ammonium halides, such as, ammonium chloride, ammonium fluoride, ammonium bromide, and combinations thereof. Suitable halide activators are capable of reacting with the selected metal in the metallic component, for example, aluminum, to form a volatile aluminum halide, for example AlCl₃ or AlF₃. In one embodiment, the halide activator is encapsulated to inhibit absorption of moisture, such as when a water-based binder is used.

The binder corresponds to the selected metallic component and the halide activator. Suitable binders include, but are not limited to, alcohol-based organic polymers, water-based organic polymers, and combinations thereof. The binder is capable of being burned off entirely and cleanly at temperatures below that required to vaporize and react the halide activator, with the remaining residue being in the form of an ash that is easily removed, for example, by forcing a gas, such as air, over the surface of the metallic foam 118. Suitable alcohol-based organic polymer binders include, but are not limited to, low molecular weight polyalcohols (polyols), such as polyvinyl alcohol. In one embodiment, the binder also includes a cure catalyst or accelerant such as hypophosphite. In another embodiment, the binder is an inorganic polymeric binder.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is needed is:

1. A foam structure, comprising:
a cast metallic foam having pores; and
a gel within at least a portion of the pores.

2. The structure of claim 1, wherein the gel includes a metallic component, a halide activator, and a binder.

3. The structure of claim 2, wherein the metallic component includes metallic aluminum alloyed with chromium.

4. The structure of claim 3, wherein the metallic aluminum alloyed with chromium includes, by weight, about 56% chromium and about 44% aluminum, with any remainder being aluminum.

5. The structure of claim 2, wherein the metallic component includes a metallic aluminum alloyed with cobalt.

6. The structure of claim 2, wherein the metallic component includes metallic aluminum alloyed with iron.

7. The structure of claim 6, wherein the gel is devoid of particles larger than about 74 micrometers.

8. The structure of claim 6, wherein the gel is devoid of particles larger than about 149 micrometers.

9. The structure of claim 2, wherein the halide activator is selected from the group of ammonium halides consisting of ammonium chloride, ammonium fluoride, ammonium bromide, and combinations thereof.

10. The structure of claim 2, wherein the binder is selected from the group consisting of alcohol-based organic polymers, water-based organic polymers, and combinations thereof.

11. The structure of claim 2, wherein the gel includes solids, by weight, between about 10% and about 80%, with the balance being the binder.

12. The structure of claim 1, wherein the structure is a turbine seal.

13. A process of fabricating a foam structure, the process comprising:
providing a cast metallic foam having pores; and
infusing at least a portion of the pores with a gel.

14. The process of claim 13, wherein the gel is vacuum infused into the cast metallic foam.

15. The process of claim 13, wherein the gel includes a donor material including a metallic aluminum, a halide activator, and a binder.

16. The process of claim 15, wherein the metallic aluminum alloyed with chromium includes, by weight, about 56% chromium and about 44% aluminum, with any remainder being aluminum.

17. The process of claim 15, wherein the halide activator is selected from the group of halides consisting of ammonium chloride, ammonium fluoride, ammonium bromide, and combinations thereof.

18. The process of claim 15, wherein the binder is selected from the group consisting of alcohol-based organic polymers, water-based organic polymers, and combinations thereof.

19. The process of claim 13, wherein the structure is a turbine seal.

20. A turbine, comprising:
a rotating portion; and
a turbine seal, the turbine seal comprising a foam structure;
wherein the foam structure comprises a cast metallic foam having pores and a gel infused within at least a portion of the pores.
